(19) United States
(12) Patent Application Publication
(10) Pub. No.: US 2012/0090550 A1
(43) Pub. Date: Apr. 19, 2012

(54) DEVICE FOR CLEANING AND CARING FOR HOOVES OR CLAWS OF LIVESTOCK

(76) Inventor: Udo Schlicher, Enkenbach-Alsenborn (DE)

(21) Appl. No.: 13/265,202

(22) PCT Filed: Apr. 23, 2010
(86) PCT No.: PCT/IB2010/002068

§ 371 Date: Nov. 29, 2011

(30) Foreign Application Priority Data
Apr. 20, 2009 (DE) 20 2009 005 742.9

(51) Int. Cl. A01K 13/00

(52) U.S. Cl. 119/669

(57) ABSTRACT

The invention relates to a device for cleaning and caring for hooves or claws of livestock. In order to create a device for ensuring sufficient hygiene and cleanliness of hooves or claws of livestock, which device allows reliable disease prevention even in large herds, and, at the same time, can be operated with little work effort, it is proposed, within the scope of the invention, that a trough is provided, above which a walkway is disposed, on which the livestock can cross the trough, whereby nozzles are disposed in the region of the walkway, for spraying the hooves or claws with cleaning solution, and that at least one other nozzle is provided at the end of the walkway, which nozzle can be supplied with fresh care solution from a separate tank. The invention is based on the recognition that walk-through claw baths promote transfer of disease within a herd unless a bath change takes place very frequently, but in practice, this is hardly possible. Furthermore, it has been shown, within the scope of the invention, that it is practical to carry out the step of cleaning the hooves or claws and caring for them separately, one after the other.

The invention relates to a device for cleaning and caring for hooves or claws of livestock.

The hooves or claws of livestock are very sensitive body parts, because of the permanent stress on them. Moisture, in particular, can lead to numerous diseases of the hooves or claws. For example, outbreaks of inflammation of the skin of the toes in cattle (Latin Dermatitis digitalis, also called Mortellaro after its discoverer) are promoted by moisture acting on the ball of the claw. Functional claw care is of greatest importance for prophylaxis. In the case of diseased individual animals, local treatment with sprays that contain antibiotics (for example oxytetracycline) is recommended; in the case of a large proportion of diseased animals of a herd, walk-through claw baths are recommended.

Manual cleaning to ensure sufficient hygiene in the claw sector is at most possible in very small herds, because the expenditure of time connected with this is significant. While it is true that walk-through claw baths are less personnel-intensive, they are disadvantageous because they quickly become dirty.

It is the task of the invention to create a device for ensuring sufficient hygiene and cleanliness of hooves or claws of livestock, which device allows reliable disease prevention even in large herds, and, at the same time, can be operated with little work effort.

This task is accomplished, according to the invention, in that a trough is provided, above which a walkway is disposed, on which the livestock can cross the trough, whereby nozzles are disposed in the region of the walkway, for spraying the hooves or claws with cleaning solution, and that at least one other nozzle is provided at the end of the walkway, which nozzle can be supplied with fresh care solution from a separate tank.

The invention is based on the recognition that walk-through claw baths promote transfer of disease within a herd unless a bath change takes place very frequently, but in practice, this is hardly possible. Furthermore, it has been shown, within the scope of the invention, that it is practical to carry out the step of cleaning the hooves or claws and caring for them separately, one after the other. Of course, the device can be used by authorized persons, for example veterinarians, also for veterinary medical care of diseases of the hooves or claws.

It is significantly more practical to clean the hooves or claws of livestock by means of nozzles, as they are passing through the trough, rather than cleaning them as the livestock are walking through a walk-through claw bath, and after the cleaning has taken place, to spray the hooves or claws with fresh care solution, for example a hydrogen peroxide solution, which might be mixed with silver ions, if necessary. In this connection, it is true that the cleaning fluid in the trough is recirculated, but the pathogen load in the cleaning solution is clearly reduced by means of the introduction of the fresh care solution into the trough, in each instance. It is practical to operate the nozzles at a relatively great throughput and low pressure, because the hooves or claws of the livestock are very sensitive.

In this connection, it has been proven to be particularly advantageous that means for spraying the care solution onto the underside of the hooves or claws are provided.

The means can be nozzles having a specific output direction. Alternatively or in addition, deflection devices (for example in the form of baffles) can also be present, by means of which the cleaning solution or care solution is guided in the appropriate direction.

In this connection, it is advantageous if the claw gap is also flushed with the cleaning solution or the care solution, respectively.

It has proven to be particularly efficient to apply the care solution to the underside of the hooves, because this comes into contact with moisture and disease pathogens to a particularly great degree.

A preferred embodiment of the invention consists in that the nozzles are plate nozzles.

The plate nozzles make it possible to form a horizontal spray film through which the hooves or claws of the livestock must pass multiple times when walking over the walkway, so that it is ensured that the underside of the hooves or claws is also cleaned and wetted with care solution.

It has furthermore proven to be practical that the nozzles are disposed centered on the walkway, and spray toward the outside.

Furthermore it is practical that the device is disposed ahead of or directly after the milking parlor.

It is advantageous to allow the care solution to act during the milking process, which takes approximately 10 minutes. If this is not possible, it is preferably disposed directly after the milking parlor.

It is part of the invention that the device has a cleaning sector and a care sector that is separate from the former.

The spatial separation of these two sectors makes it possible to apply the care solution to the hooves or claws that have already been cleaned.

A further development of the invention consists in that the device has a preservative sector separate from the cleaning sector and the care sector.

This sector, too, is preferably spatially separated from the two other sectors, and the preservative solution applied in this sector serves to extend the period of effect of the care solution.

It is advantageous that the walkway is configured as a grate, as a floor having gaps for draining off the fluids, or as a closed floor.

In this connection, a further development of the invention consists in that the floor is configured with gaps, or the closed floor is configured as a rubber floor that has profiling on its top surface.

In the following, an exemplary embodiment of the invention will be explained using drawings.

These show:

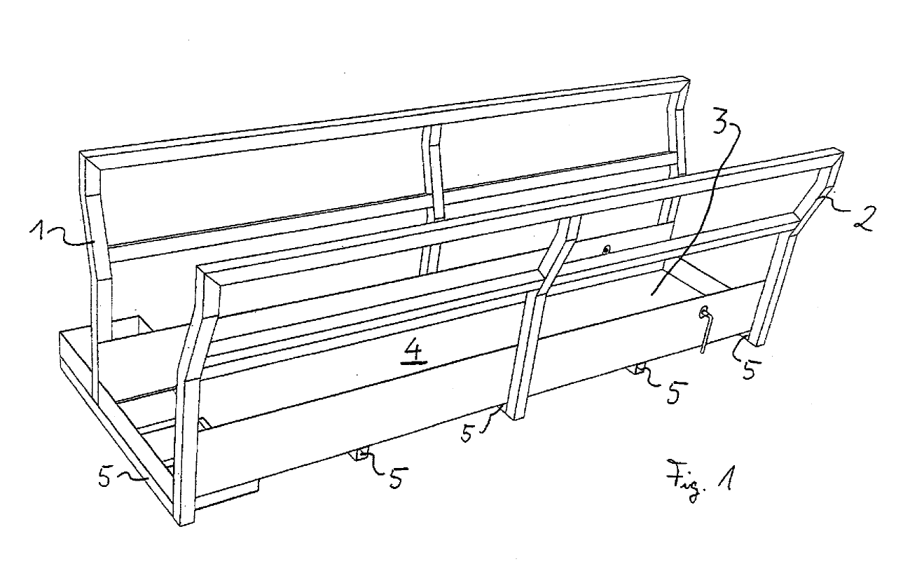

FIG. 1 a walk-through bath with lateral guides and a trough,

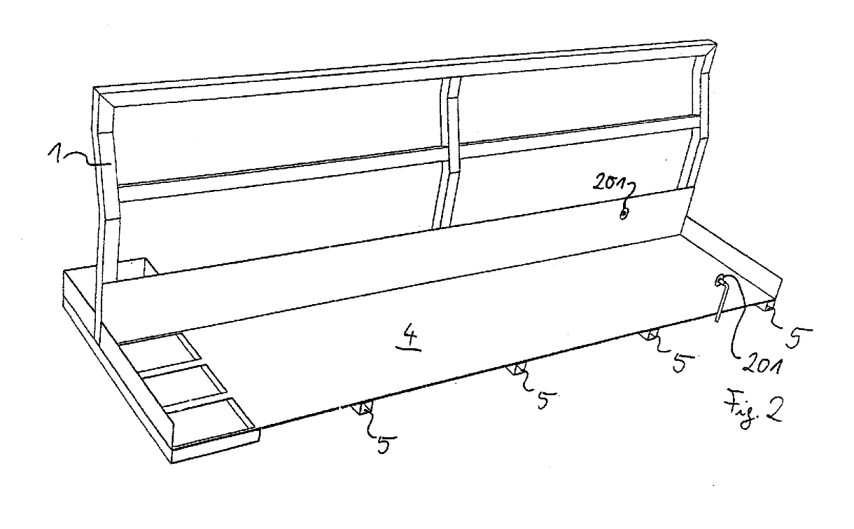

FIG. 2 the walk-through bath according to FIG. 1 in lateral section,

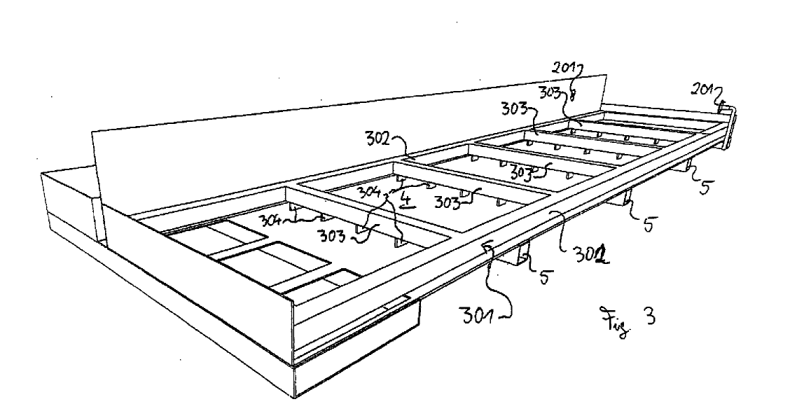

FIG. 3 the walk-through bath in the section according to FIG. 1 with a carrier for a walkway in the form of a grating,

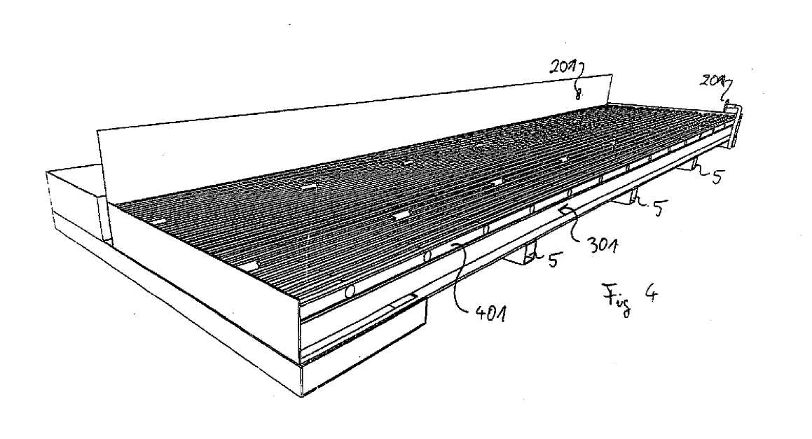

FIG. 4 the walk-through bath according to FIGS. 2 and 3 with the grating,

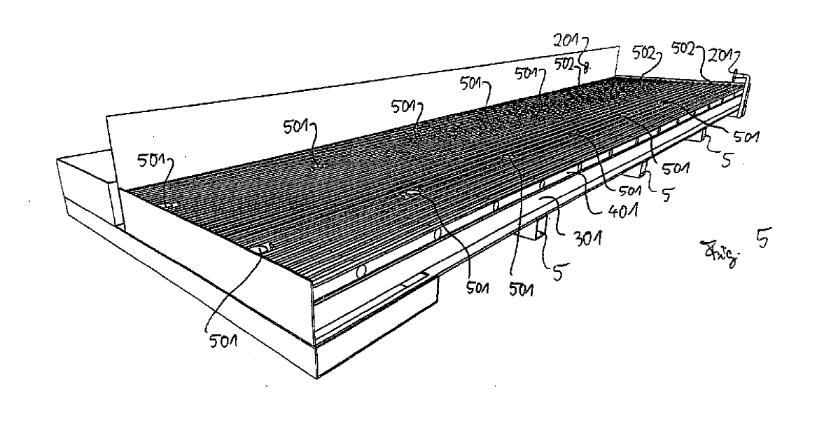

FIG. 5 the walk-through bath according to FIG. 4 with the plate nozzles,

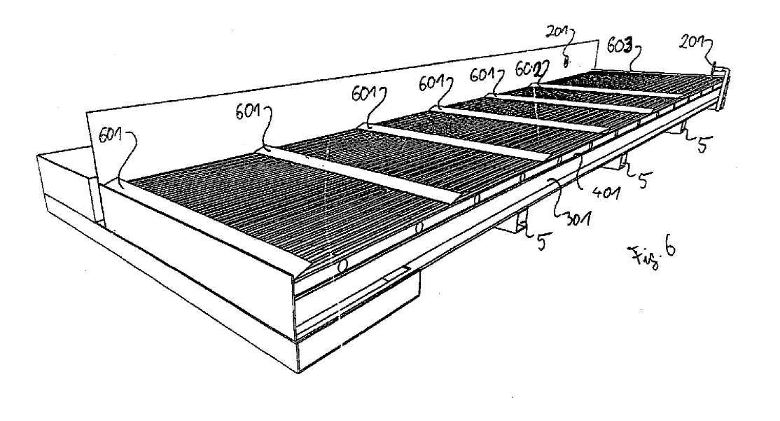

FIG. 6 the walk-through bath according to FIG. 5 with the baffles,

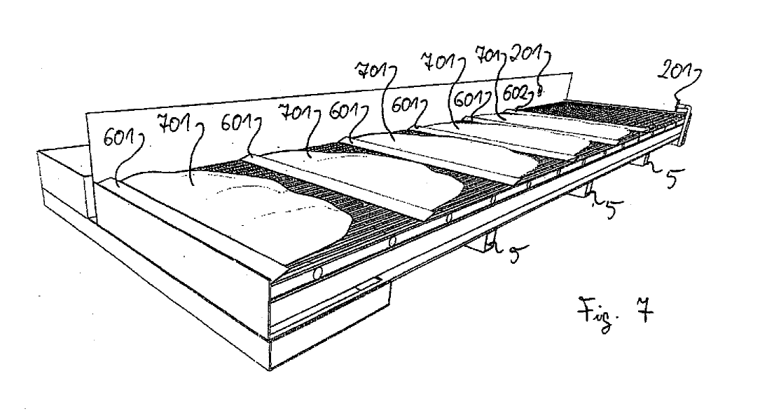

FIG. 7 the walk-through bath according to FIG. 6 with cleaning solution exiting from it,

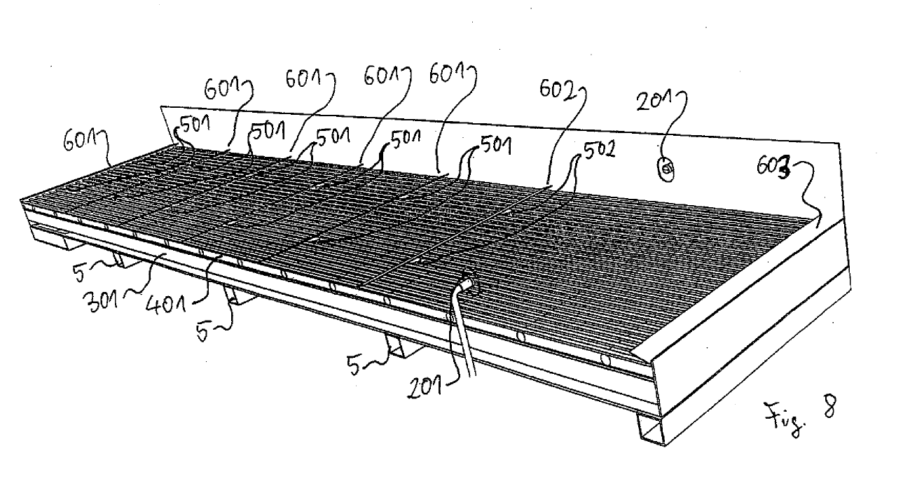

FIG. 8 the walk-through bath according to FIG. 6 in a view of the walking direction of the animals from the front, at a slant,

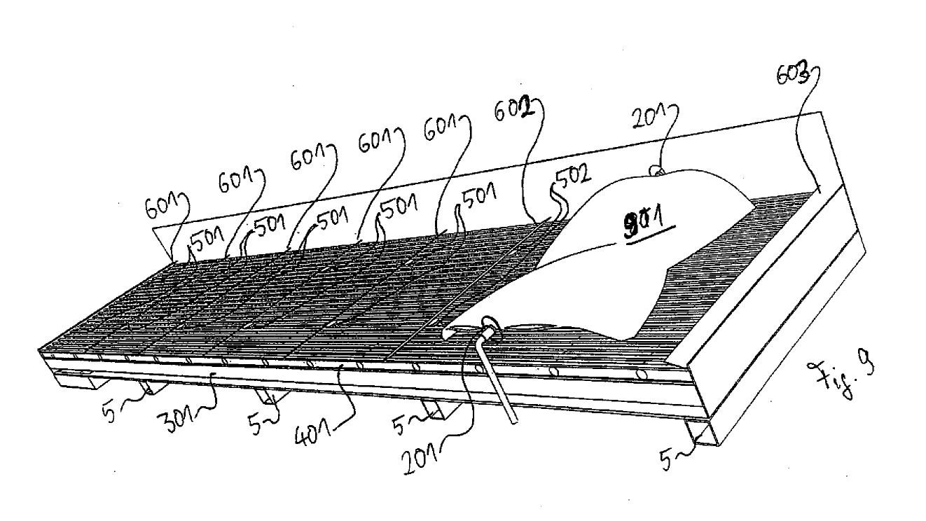

FIG. 9 the walk-through bath according to FIG. 8 with the care solution exiting from lateral nozzles, and

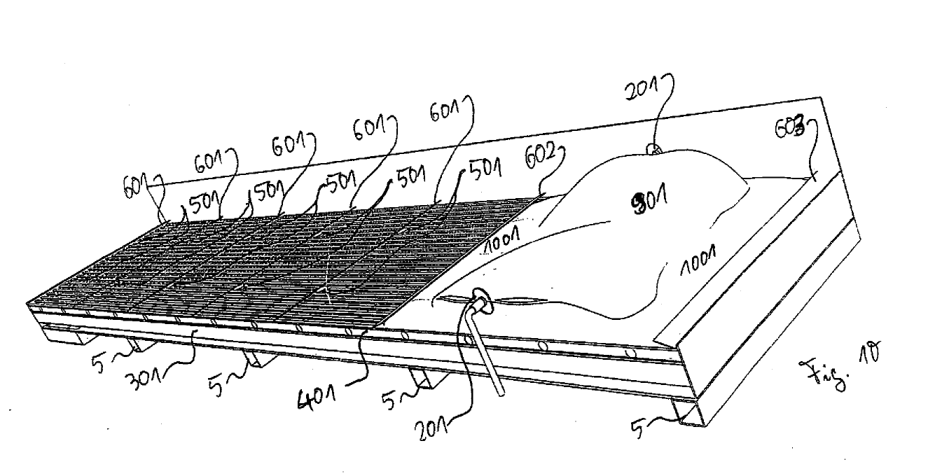

FIG. 10 the walk-through bath according to FIG. 8 with care solution exiting from lateral nozzles as well as care solution exiting from plate nozzles disposed in the walking plane.

FIG. 1 shows a walk-through bath having lateral guides 1, 2 and a trough 3. Below the trough bottom 4, lateral cross-beams 5 are affixed, in order to carry the loads when the animals walk across the walkway, configured as a grating, which covers the trough 3. This walkway, configured as a grating here, will still be explained in further detail in connection with other drawings.

Vertical cross-bars, which are part of the lateral guides 1 and 2, can be attached to the lateral cross-beams.

FIG. 2 shows the walk-through bath according to FIG. 1 in lateral section. In this connection, the lateral guide 2 is no longer shown.

The perspective of FIG. 2 shows the walk-through bath in a view in the walking direction of the animals, from the rear, at a slant.

It can be seen that lateral nozzles 201 are provided at the end of the walk-through bath, in the walking direction of the animals, by means of which nozzles a care solution for hygiene care of the animals is output. It is advantageous if these nozzles 201 are affixed in such a manner that they are disposed above the walking plane of the animals.

FIG. 3 shows the walk-through bath in the section according to FIG. 1, with a beam 301 for a walkway configured as a grating. This beam 301 has a longitudinal beam 302 and a transverse beam 303. The transverse beam stands on feet 304 of the trough bottom 4.

This proves to be advantageous in that a mixed fluid, extensively uniform in composition, is present in the trough. In particular, the cleaning fluid in the trough 4 is mixed with the care solution, which is introduced at the end of the walk-through bath, in the entry region of the walk-through bath. In this way, the number of pathogens is advantageously reduced.

FIG. 4 shows the walk-through bath according to FIGS. 2 and 3 with the walkway 401 configured as a grating. It can be seen that holes are present in the walkway 401. Subsequently, plate nozzles are placed in these holes, to dispense the cleaning solution as well as the care solution.

FIG. 5 shows the walk-through bath according to FIG. 4 with the plate nozzles 501 and 502. It is advantageous if the plate nozzles are the same in their construction. However, in the following, it will still be seen that the cleaning solution is dispensed by way of the plate nozzles having the reference number 501, and the care solution is dispensed by way of the plate nozzles having the reference number 502.

FIG. 6 shows the walk-through bath according to FIG. 5 with baffles 601 and 602. These baffles are disposed transverse to the walking direction of the animals and extend at a slant, upward, in the walking direction. The plate nozzles 501 are covered by the baffles 601, and a row of the plate nozzles 502 is covered by the baffle 602.

The baffles 601, 602 protect the plate nozzles, for one thing, from damage by the hooves or claws of the animals, because they would otherwise step on the plate nozzles directly while walking. For another thing, the cleaning solution and care solution dispensed by the plate nozzles, in each instance, are applied at a slant, from the rear, in the walking direction of the animals, particularly also to the underside of the hooves or claws of the animals. In this way, the underside of the hooves or claws is efficiently cleaned, and the care solution is efficiently applied to the underside of the hooves or claws, as the result of the movement of the hooves or claws while walking (roll-over movement).

Furthermore, a baffle 603 is affixed all the way at the end of the walk-through bath, which baffle also covers plate nozzles 502, by way of which the care solution is dispensed. This baffle 603 is also disposed transverse to the walking direction of the animals, but extends at a slant to the rear, counter to the walking direction of the animals. As a result, the care solution is dispensed at a slant to the rear by way of the plate nozzles 502 all the way at the end of the walk-through bath.

FIG. 7 shows the walk-through bath according to FIG. 6 with exiting cleaning solution 701. The cleaning solution 701 is applied, in part, directly in the walking direction of the animals, at a slant from the rear, from below, to the hooves or claws of the animals. To the extent that the cleaning solution is sprayed counter to the walking direction of the animals, by means of the plate nozzles, this part of the cleaning solution is deflected back into the walking direction of the animals by means of the baffles 601.

FIG. 8 shows the walk-through bath according to FIG. 6 in a view in the walking direction of the animals, at a slant from the front. The representation in FIG. 8 therefore corresponds to the representation of FIG. 6 from a different perspective.

FIG. 9 shows the walk-through bath according to FIG. 8 with the care solution 801 exiting from the lateral nozzles 201 at the end of the walk-through bath.

FIG. 10 shows the walk-through bath according to FIG. 8 with care solution 901 exiting not only from the lateral nozzles 201 but also from plate nozzles disposed in the walking plane, which nozzles can no longer be seen in the representation of FIG. 10, because of the representation of the care solution 1001. The care solution 1001 is formed into a lake, through which the animals walk at the end of the walk-through bath, by the baffles 602 and 603.

In total, it can be described, in summary, that cleaning and hygiene care of the hooves or claws takes place in two phases. The first phase is cleaning, and the second phase is hygiene care. A third phase for a preservative can be implemented by means of further nozzles at the exit from the facility. The animals (for example dairy cows) pass through these phases one after the other. It is advantageous if the facility is integrated into the path between the stall and the milking facility, so that the care solution can act on the dairy cow while she is standing quietly in the milking parlor, without being worn off again right away because the dairy cow is walking around. If this is not possible, it has proven itself to be necessary to place the facility directly behind the milking parlor.

The stepping surface of the facility, which can be structured as a grating, for example, is configured to be slip-resistant (for example according to Class 13). In place of a grating, a floor with gaps for draining away the fluids or a closed floor can also be provided. In the case of a floor with gaps or a floor with a closed surface, it has proven to be particularly advantageous to use a rubber floor that preferably has a profiling on its top surface. In the case of a floor with a closed surface, flotation is achieved when the fluid flows around an obstacle (hoof or claw). In the case of such floors, it is practical to dispose gaps for draining the cleaning solution or care solution and solids in the edge region, in order to keep the overall surface clean. In this way, it is ensured that the movement energy of the fluid that is used for after-rinsing is not used up for forward movement of the liquid/solid mixture.

As can be seen in the figures, the walkway runs in the longitudinal direction, parallel to the walking direction of the animals. The distance between the longitudinal profiles is selected in such a manner that stable support of the claw or hoof is guaranteed. This proves to be advantageous in that the feces of the dairy cows are basic and otherwise, any walking surface having an unsuitable surface structure would become slippery, so that the animals would be at risk.

Entry and exit of the animals onto and from the walkway is implemented by means of the smallest possible height differences, in order to guarantee a risk of injury by means of the smallest possible height differences. This is important because of the relatively great inherent weight of the cows, particularly when stepping down, because the claws of the cows are then subjected to clearly greater stress.

The first phase (cleaning) has the following characteristics:
Cleaning by means of water or a cleaning solution in the walking direction of the animals
Cleaning Of the underside of the claw as well as the claw gap from the rear, in the walking direction.

As a result, the claw and, in particular, the claw gap are flushed out. The diseased locations or the locations at risk of disease are exposed and can subsequently be cared for.

The second phase (care) has the following characteristic features:
Application of the care solution for hygiene care, by way of nozzles (spray nozzles)
In this connection, it is advantageous if nozzles affixed laterally, which cover the claws of the animals with mist, are also present.

In this connection, it is advantageous if a spray solution that disinfects on the basis of hydrogen peroxide is used. The solution is completely biodegradable and does not harm the health of the animals, and also does not bring with it any pollution of the animal products (milk, meat).

A third phase that might be present (preservative) has the following characteristic features:
Application of the preservative solution for longer effectiveness of the care solution, by way of nozzles (spray nozzles)
In this connection, it is advantageous if nozzles affixed laterally, which cover the claws of the animals with mist, are also present.

It is advantageous if a spray solution that seals the surface on the basis of nanoparticles is used in this connection. The solution is completely biodegradable and does not harm the health of the animals, and also does not bring with it any pollution of the animal products (milk, meat).

There are various possibilities of configuring the facility for Phase 1 (cleaning).

Aside from the examples shown here in the drawing, it should also be explained that washing nozzles that inject a cleaning solution from one side can also be provided for the cleaning process. In this connection, then, not only nozzles 201 in accordance with the representation of FIG. 2 are present, as lateral nozzles, for introduction of the care solution. Depending on the number of nozzles required, several of these lateral nozzles are then present also for introducing the cleaning solution, accordingly.

Likewise, washing nozzles can be configured as plate nozzles that are countersunk in the grating and have a water exit in the walking direction of the animals. Depending on the pace length of the animals, these nozzles are disposed at a distance of approximately 0.3 m-0.5 m. The exit of water or the exit of cleaning solution takes place, in each instance, in the form of a half-circle, in the walking direction of the animals.

Likewise, the washing nozzles can be disposed under sheets of metal that are affixed transverse to the walking direction, every 0.3 m to 0.5 m. The sheets of metal are sprayed on from below and deflect the cleaning solution or the care solution in the walking direction of the animals, accordingly. This exemplary embodiment has been explained in greater detail above, in the figures.

Alternatively, the gaps in the grating can also be filled with profiled metal sheets. In this connection, the washing nozzles for implementing Phase 1 can advantageously be affixed only at the beginning of the walkway, and spray in the walking direction of the animals. The water or the cleaning solution runs off only at the end of the segment for implementing Phase 1, and also transports all the animal feces and dirt away from the facility by way of the flushing path. It is advantageous, in this connection, if the gaps below the grating are separated from one another in the longitudinal direction, in order to improve removal of animal feces and dirt in the walking direction of the animals, to the end of the segment for implementing Phase 1.

It is preferable if the facility has a screen-belt filter that is preferably installed at the end of the facility, transverse to the walking direction, and serves to remove solids to the side. Alternatively, the screen-belt filter can also be integrated into a separate container that is used as a collection tank.

The screen-belt filter serves to separate the solids from the liquid, which makes it possible to recirculate the liquid. In the case of recirculation of the liquid, with a correspondingly relatively small amount of liquid, it is possible to drain off the entire amount of liquid after milking and to use fresh water for the next cleaning and care sequence. The small total consumption of fresh water and waste water that is made possible by recirculation brings reduced operating costs with it.

1. Device for cleaning and caring for hooves or claws of livestock, wherein a trough (3, 4) is provided, above which a walkway (401) is disposed, on which the livestock can cross the trough (3, 4), whereby nozzles (501) are disposed in the region of the walkway (401), for spraying the hooves or claws with cleaning solution (701), and wherein at least one other nozzle (502, 201) is provided at the end of the walkway (401), which nozzle can be supplied with fresh care solution (901, 1001) from a separate tank.

2. Device according to claim 1, wherein means (501, 502, 601, 602) for spraying the cleaning solution and/or care solution onto the underside of the hooves or claws, at least in part, are provided.

3. Device according to claim 2, wherein the nozzles (501, 502) are plate nozzles.

4. Device according to claim 1, wherein the nozzles (501, 502) are disposed at least essentially centered on the grating (401) and spray toward the outside.

5. Device according to claim 1, wherein the device is disposed ahead of or directly after the milking parlor.

6. Device according to claim 1, wherein the device has a cleaning sector and a care sector that is separate from the former.

7. Device according to claim 6, wherein the device has a preservative sector that is separate from the cleaning sector and the care sector.

8. Device according to claim 1, wherein the walkway is configured as a grating, as a floor with gaps for draining the fluids, or as a closed floor.

9. Device according to claim 8, wherein the floor with gaps or the closed floor is configured as a rubber floor that has a profiling on its top surface.
